(19) United States
(12) Patent Application Publication
(10) Pub. No.: US 2023/0383073 A1
(43) Pub. Date: Nov. 30, 2023

(54) SINGLE-LAYER MONOLITHIC WATERPROOF BREATHABLE FILM

(71) Applicant: PROCHIMIR, Pouzauges (FR)

(72) Inventor: Adrien BIRONEAU, Pouzauges (FR)

(21) Appl. No.: 18/034,125

(22) PCT Filed: Oct. 28, 2021
(86) PCT No.: PCT/FR2021/051900

§ 371 Date: Apr. 27, 2023

(30) Foreign Application Priority Data
Nov. 3, 2020 (FR) FR2011273

(51) Int. Cl. C08J 5/18; B32B 27/34; B32B 27/28; B32B 27/32; B32B 27/08; B32B 27/36; B32B 27/40; B32B 27/12; B32B 5/02

(52) U.S. Cl. CPC C08J 5/18; B32B 27/34; B32B 27/285; B32B 27/32; B32B 27/08; B32B 27/36; B32B 27/40; B32B 27/12; B32B 5/02; C08J 2353/00; C08J 2375/08; B32B 2250/40; B32B 2270/00; B32B 2307/726; B32B 2307/746; B32B 2307/406; B32B 2274/00; B32B 2307/538; B32B 2250/24; B32B 2307/7376; B29C 48/001

(57) ABSTRACT

A monolayer monolithic waterproof-breathable film A with a thickness between 5 and 150 μm consists of at least 50% by weight of a highly breathable polymer. One of its faces exhibits an arithmetical mean roughness Ra of at least 0.1 μm. A process for manufacturing said film includes a stage (i) of formation, by coextrusion, of a multilayer film M comprising a bilayer B/A, wherein the layer A is as defined above. The layer B is a peelable layer with a thickness between and 100 μm and consisting of a dispersion of high density polyethylene (HDPE) in a continuous phase of atactic polypropylene. The amount of dispersed HDPE is such that layer B exhibits an arithmetical mean surface roughness Ra of at least 0.1 μm. Stage (ii) of the process includes separating the monolayer film A by peeling off the layer B in the multilayer film M.

### FIELD OF THE INVENTION

A subject matter of the present invention is a monolayer monolithic waterproof-breathable film, a process suitable for its manufacture by co-extrusion, and also a composite product (or laminate) comprising it.

### TECHNICAL BACKGROUND

Waterproof-breathable films (also called “breathable films”) are widely used for the manufacture of articles in various fields which include the field of clothing, in particular sportswear or surgical protective clothing, and personal protective equipment, and also the construction field, in particular under-roof insulation of dwellings.

In these various fields, it is important to have available barrier films for protection against liquids, in particular against water, especially waterproof-breathable films, which however provide for the moisture vapor transmission.

For example, in the case of sportswear, such as hiking jackets, it is important to protect the hiker against rain while promoting breathability, in order to make possible the evaporation of perspiration and to thus ensure the comfort of the hiker. It is also desirable to ensure this same comfort for surgeons, nurses or even patients, who, during surgical operations, must be protected from any contact with body fluids, infectious agents or chemicals. Mention may be made, among the corresponding protective clothing, of gowns worn by surgeons and nurses, and surgical drapes placed on patients during operations.

Among waterproof-breathable films, monolithic waterproof-breathable films are known which are continuous films substantially devoid of pores. Such films are advantageous compared to microporous waterproof-breathable films in that their barrier property with respect to liquids, and in particular water, is independent of the surface tension. Monolithic waterproof-breathable films also exhibit a better barrier effect against viruses or odors and better maintenance of the breathability properties over time.

Waterproof-breathable films are generally obtained by shaping highly breathable polymers. A highly breathable polymer is a polymer which is permeable to moisture vapor and substantially impermeable to liquid water, and which is thus suitable for obtaining a waterproof-breathable film. More specifically, the term “highly breathable polymer” is intended to denote a thermoplastic polymer which, when it is put into the form of a film having a thickness of 15 μm, exhibits a high moisture vapor transmission rate (or MVTR), more specifically of at least 1000 g/m²/day, preferably of at least 1500 g/m²/day. The MVTR is measured according to the standard ASTM E96B at 38° C. and 50% relative humidity.

Highly breathable polymers are thermoplastic elastomer polymers (hereinafter denoted by TPEs) which are, for example, chosen from:
copolymers having polyamide and polyether blocks (hereinafter denoted by TPAs), such as Pebax® from the Arkema group;
copoly(ether-urethane)s or Thermoplastic PolyUrethanes (hereinafter denoted by TPUs), such as Estane® from the Lubrizol group; and
copoly(ester-ether)s or thermoplastic elastomer copolyesters (hereinafter denoted by TPCs), such as Arnitel from DSM or Hytrel from DuPont.

These thermoplastic elastomer polymers are available in the form of granules which are converted into film by specialist converting industrialists.

These waterproof-breathable films are generally employed to form laminated (or complex) products by attachment to at least one porous support layer, which can consist of a woven or nonwoven fibrous material. Such laminates are used for the manufacture of the abovementioned articles, such as sportswear, or for the manufacture of certain parts of said articles. These laminated products are obtained by lamination (or complexing) of the monolayer breathable film on the fibrous support layer by noncontinuous or continuous coating with an adhesive, such as a hot-melt adhesive.

Such adhesive bonding operations are carried out by industrialists who are specialists in lamination (often called laminators) in machines which operate continuously with generally high line speeds and in which both the individual layers and the final laminated product are, because of their very large dimensions, packaged by winding in the form of wide reels, the width (or machine width) of which can range up to approximately 3 m and the diameter of which up to approximately 1 m.

It is thus necessary, with a view to these lamination operations, to have available the waterproof-breathable film packaged by winding in the form of such reels.

However, both the obtaining of such wound products, during the manufacture of the film by the converters, and their use, in the subsequent lamination operations, is sometimes likely to come up against a problem of “blocking”.

This term “blocking” denotes the difficulty or sometimes the impossibility of carrying out, under the line speed conditions suitable for industrial production, the winding of a film on a reel or the unwinding of the film thus wound. This difficulty is manifested by a nonuniform speed for the reel concerned, which can range as far as jerks, and by the appearance of significant tensile forces in the film which can lead as far as to its breakage.

Such a problem generally results from a residual tack exhibited by the surface of said film, which is reflected by a resistance (or friction) to the relative sliding movement between the two surfaces of said film which are in contact during reel winding or unwinding. This friction can be quantified by means of the coefficient of friction.

There is known, from the application WO 2016/100699 of Polymer Group, a multilayer waterproof-breathable film which comprises a monolithic central layer comprising a highly breathable polymer and two outer layers, adjacent to each of the two faces of the central layer. These outer layers necessarily comprise, in addition to a highly breathable polymer and a nonbreathable material, a filler in the form of particles or of aggregates of particles.

Said particles have a median diameter which is greater than the thickness of said outer layers, and thus form projections (or protuberances) on the free surface of each of these outer layers, which are nonpeelable.

This multilayer waterproof-breathable film advantageously exhibits, when it is wound on a reel, a reduced tendency to blocking, which is quantified by a low coefficient of friction. Said film can be prepared by a flat co-extrusion process, which includes a treatment with a specific roller, capable of giving it a matte appearance.

However, the employment of fillers in the outer layers is liable to result in a decrease in the breathability.

There is also known, in the prior art, a monolithic and monolayer waterproof-breathable film A1, the thickness of which ranges from 8 to 60 μm and which consists of a composition (a1) itself consisting of at least 50% by weight of one (or more) highly breathable polymers and of up to 50% by weight of various additives.

Said film is manufactured by a process which comprises:
a stage of formation, by co-extrusion, of a multilayer film F1 consisting of a bilayer B1/A1 or of a trilayer B1/A1/C1, in which the layers B1 and C1 are each a peelable layer, the thickness of which ranges from 15 to 100 μm and consists, respectively, of compositions (b1) and (c1) of low density polyethylene (LDPE); then
a stage of separation of the layer A1, by simple peeling of the layer B1 and, when it is present, of the layer C1.

It is clearly understood that the sign “I” used above in the designation of the multilayer films from their constituent layers means that the faces of the layers concerned are in direct contact. It is the same, in the absence of contrary details, for all the multilayer structures described in the present text.

Such a process is implemented by coextrusion by film blowing and comprises:
the introduction, into separate extruders, of the compositions (a1), (b1) and optionally (c1), in the form of granules with a size of between 1 and 10 mm; then
the transformation by heating said granules to the molten state; then
the passage of the corresponding flows through an extrusion head comprising a set of coplanar and concentric annular dies, which head is brought to a temperature ranging from 150° C. to 260° C., so as to form, by injection of pressurized air, a tubular bubble (or sheath) in the shape of a cylinder having several layers, the order of the layers of which corresponds to that desired for the final film, the layer A1 being on the outside of the tubular sheath in the case of the bilayer B1/A1; then
the radial (relative to the plane of the annular dies) expansion and the drawing (in the direction perpendicular to said plane) of the bubble, then
the cooling of said bubble.

The cylindrical bubble thus formed is in addition generally flattened by passing between two nipper rolls, then subjected to cutting in the vicinity of the two edges, so as to obtain two separate films which are then each packaged in the form of windings around a reel. In this known embodiment of the prior art, the support layers B1 and C1, often consisting essentially of LDPE, have the function, during the implementation of this process, of maintaining the stability of the tubular bubble and of thus facilitating the shaping of the highly breathable polymer to give a monolithic and monolayer waterproof-breathable film (A1). According to a more specific embodiment of the prior art, the support layers B1 and C1 are identical and called S1, so that the film F1 is a symmetrical trilayer S1/A/S1.

Said layers (B1) and (C1), which are chemically incompatible with the layer (A1), are intended to be removed subsequently, during a peeling stage (also called stripping), in order for the laminators to be able to carry out the operations of lamination of the single monolithic and monolayer waterproof-breathable film (A1) with the fibrous support layer.

However, the surface of said monolayer film A1 which, according to this same embodiment of the prior art, is obtained after removal of one or both of the outer layers B1 and C1 exhibits, at ambient temperature, a tackiness (or tack) which has the effect of causing said film to stick to itself, which is reflected by a high coefficient of friction which results in the undesirable blocking phenomenon. On the contrary, blocking is not observed in the case of the bilayer film B1/A1 or of the trilayer film B1/A1/C1.

Thus the converter, who manufactures the monolayer film A1 by shaping the highly breathable polymer, must package said film A1 with at least one of the two support layers B1 and C1 for its delivery to the laminator. The latter thus necessarily, as an operation prior to the lamination of said film A1 onto the fibrous support layer, has to peel off the support layer present in the reel received from the converter. The presence of said support layers thus involves, for the laminator, a complication of the process which he is implementing, and also poses a problem for him due to the elimination of the waste consisting of the support layer once peeled, and to its reprocessing with a view to its recyclability.

Furthermore, the surface of the monolayer monolithic waterproof-breathable film A1 of this same embodiment of the prior art also exhibits a shiny appearance which must be avoided, with a view to certain final applications. This is the case, for example, of the waterproof-breathable films intended for the manufacture of gowns worn by surgeons and nurses during surgical operations, due to annoying reflections from the powerful lighting of operating theaters. For such an application, a matte appearance of the surface of the monolayer breathable films is highly desirable.

It is an aim of the present invention to provide a monolithic waterproof-breathable film which can be packaged, then employed, wound on a reel, without an outer layer.

Another aim of the present invention is to provide a monolithic waterproof-breathable film, the windings of which on a reel do not exhibit blocking or exhibit a reduced blocking.

Another aim of the present invention is to provide a monolithic waterproof-breathable film which exhibits a lowered coefficient of friction.

Another aim of the present invention is to provide a monolithic waterproof-breathable film, the breathability of which is preserved, in particular over time.

Another aim of the present invention is to provide a monolithic waterproof-breathable film exhibiting a matte appearance.

Another aim of the present invention is to provide a monolithic waterproof-breathable film which can be manufactured by a coextrusion process which does not include passage over a mattifying roller.

It has now been found that these aims can be achieved in all or in part by means of the monolithic waterproof-breathable film which is a subject matter of the present invention.

### DESCRIPTION OF THE INVENTION

Monolayer Monolithic Waterproof-Breathable Film A:

The invention thus relates first to a monolayer monolithic waterproof-breathable film A, the thickness of which is of between 5 and 150 μm, which consists of a composition (a) comprising at least 50% by weight, on the basis of the total weight of said composition, of a highly breathable polymer, and which is characterized in that at least one of its two faces exhibits an arithmetical mean roughness Ra of at least 0.1 μm.

It has been found that said film advantageously exhibits a matte (in other words nonshiny) appearance, and can be packaged in the form of windings on a reel and then unwound, under industrial line speed conditions, without exhibiting blocking. The surface provided with the roughness as defined above results in particular in a lowered coefficient of friction during the relative sliding movement of said surface in contact with the other surface. Finally, the film according to the invention exhibits a breathability, quantified by the MVTR measured in accordance with the standard ASTM E96B at 38° C. and 50% relative humidity for a film thickness of 15 μm, which is of at least 1000 g/m²/day, preferably of at least 1500 g/m²/day, more preferentially of at least 2000 g/m²/day and more preferentially still of at least 2500 g/m²/day. Such a monolithic waterproof-breathable film additionally exhibits the advantages in terms of industrial logistics of a monolayer compared to the multilayer systems of the prior art, both for the converter of the highly breathable polymer and for the laminator of said film.

The arithmetical mean roughness Ra is measured using a stylus profilometer. A stylus profilometer is an instrument which has a very fine tip, often made of diamond, attached to the stylus, which reads the height when it is moved along a surface, with a vertical accuracy which can reach 5 angstroms. It is used to measure the relief of a surface, in particular with the aim of evaluating the roughness or the microgeometry thereof. It thus makes possible the thickness measurement just as easily of thin layers of a few tens of nanometers as that of coatings of several hundreds of micrometers. Such profilometers are commercially available, such as, for example, the Dektak XT profilometer from Bruker.

The arithmetical mean roughness Ra represents the mean of the differences between the peaks and valleys present at the surface measured. Expressed in μm, it is defined according to the standard ISO 4287 of April 1997 as being the arithmetical mean deviation of the absolute values of the ordinates (or heights) of the projections (or peaks) and of the valleys of the profile measured.

According to a preferred alternative form of the monolayer monolithic waterproof-breathable film according to the invention, at least one of its two faces exhibits an arithmetical mean roughness Ra of at least 0.3 μm and more preferably still of at least 0.5 μm.

According again to a preferred embodiment, at least one of the two faces of the film according to the invention exhibits, in addition to the characteristic defined above for the Ra, a number of peaks per unit of length RPc of at least 40, preferably of at least 50 and more preferably still of at least 60. The number of peaks per unit of length RPc is defined by the standard ISO 4287 of June 2009 and is also determined by measurement using a stylus profilometer.

According to one embodiment of the invention, the characteristic of arithmetical mean roughness Ra, as defined above, is presented by each of the two faces of the film according to the invention.

According to a more preferred embodiment, the characteristic of number of peaks RPc, as defined above, is in addition also presented by each of the two faces of the film according to the invention.

In the case of these last two embodiments, the film can be very particularly easy to wind and unwind in an industrial unit on both its faces, without risk of blocking.

The monolayer monolithic waterproof-breathable film A, according to the invention, generally has a thickness which is of between 5 and 150 μm.

According to one embodiment, said thickness is within a range extending from 6 to 100 μm, preferably from 8 to 50 μm and particularly preferably from 8 to 30 μm.

Composition (a) of the Layer A:

The composition (a) of which the monolayer monolithic waterproof-breathable film A according to the invention consists comprises at least 50% by weight, based on the total weight of said composition, of at least one highly breathable polymer.

The highly breathable polymer is preferably a thermoplastic elastomer polymer, the moisture vapor transmission rate (or MVTR) of which, measured according to the standard ASTM E96B at 38° C. and 50% relative humidity on a film of said polymer with a thickness of 15 μm, is greater than or equal to 1000 g/m²/day, preferably greater than or equal to 1500 g/m²/day, more preferentially of at least 2000 g/m²/day and more preferentially still of at least 2500 g/m²/day.

According to one embodiment, the highly breathable polymer is chosen from:
a copolymer having polyamide and polyether blocks (or TPA), such as the Pebax® products from the Arkema group;
a copoly(ether-urethane) or thermoplastic polyurethane (or TPU), such as Estane from the Lubrizol group, Desmopan® from Covestro or ELASTOLLAN® from BASF; and
a copoly(ester-ether) or thermoplastic elastomer copolyester (or TPC), such as Arnitel® from DSM or Hytrel® from DuPont.

According to a preferred alternative form, the highly breathable polymer is a copolymer having polyamide blocks and having polyether blocks.

The polyamide blocks of the copolymer having polyamide and polyether blocks can be chosen from blocks of polyamide 6, polyamide 11, polyamide 6.10, polyamide 6.12, polyamide 10.10, polyamide 10.12, polyamide 10.14, polyamide 12, and their combinations.

The polyether blocks of the copolymer having polyamide and polyether blocks can be chosen from PEG (polyethylene glycol), PPG (polypropylene glycol), PO3G (polytrimethylene glycol), PTMG (polytetramethylene glycol or polytetrahydrofuran) blocks, and their combinations.

According to a more preferred alternative form, the polyamide and polyether blocks are, respectively, a PolyAmide 11 (PA11) block and a PolyEthylene Glycol (PEG) block, the molar masses of which are within a range extending from 500 to 3000 g/mol. Such copolymers having polyamide and polyether blocks can be prepared according to either of the patent applications FR 2 846 332 in the name of Atofina or EP 1 482 011 in the name of Ube Industries.

The composition (a) can comprise one or more highly breathable polymers.

According to one embodiment, the composition (a) consists, on the basis of its total weight, of:
from 50% to 100% by weight of the highly breathable polymer(s),
from 0% to 30% by weight of additives chosen from opacifying agents, pigments, dyes, slip agents, antioxidants, antistatic agents, antiblocking agents; and
from 0% to 20% by weight of a support thermoplastic resin for said additives.

The additives can be used in amounts which vary depending on the property required.

Examples of suitable opacifying agents, pigments or dyes comprise, but without being limited thereto, iron oxide, carbon black, aluminum, titanium dioxide, talc and their combinations. A corresponding amount of 1% to 5% by weight is generally suitable.

The slip agents that can be used comprise, but without being limited thereto, higher aliphatic acid amides, higher aliphatic acid esters, waxes, silicone oils and metal soaps. An example of fatty acid slip additive which can be used is erucamide. In one embodiment, a conventional polydialkylsiloxane additive, such as a silicone oil or a silicone gum, having a viscosity of 10 000 to 2 000 000 cSt is used. An amount of these slip agents ranging from 0.5% to 6% by weight is usual.

The antioxidizing agents (or stabilizers) are introduced in order to protect the composition (a) from degradation resulting from a reaction with oxygen which is liable to be formed by the action of heat, light or residual catalysts on certain of its ingredients, including the highly breathable polymer. These compounds can include primary antioxidants, which trap free radicals and are generally substituted phenols, such as Irganox® 1010 from Ciba. The primary antioxidants can be used alone or in combination with other antioxidants, such as phosphites, for example Irgafos® 168, also from Ciba, or also with UV stabilizers, such as amines. The antioxidizing agents are generally introduced in an amount which can range up to 5% by weight.

The antistatic agents, which can be included in an amount ranging up to 20% by weight in the composition (a), comprise alkali metal sulfonates, polydiorganosiloxanes modified by a polyether, polyalkylphenylsiloxanes, tertiary amines, glycerol monostearate, mixtures of tertiary amines and glycerol monostearates, and their combinations. An example of a suitable antistatic agent is Armostat™ 475, commercially available from Akzo Nobel.

Common antiblocking additives comprise, without being limited thereto, inorganic compounds such as diatomaceous earth, natural or synthetic silica, talc, aluminum, potassium, calcium and/or magnesium silicates; or organic compounds, such as fatty acid amides, for example stearates. These antiblocking additives can be introduced in an amount ranging from 1% to 7% by weight.

Support thermoplastic resins for the additives described above are generally chosen from:
Thermoplastic PolyUrethanes (or TPUs), such as TPU-Esters or TPU-Ethers,
EVAs (copolymers of ethylene and vinyl acetate),
EBAs (copolymers of ethylene and butyl acrylate), and
TPCs.

The use of these support resins is advantageous with a view to the manufacture of the monolayer film according to the invention, which is described below.

According to a preferred alternative form of the invention, the composition (a) consists of from 80% to 100% by weight of the highly breathable polymer(s) and of from 0% to 20% by weight of said additives and also of their support resin.

According to another preferred alternative form of the invention, the composition (a) consists essentially, and more preferably still consists, of the highly breathable polymer(s).

When, in accordance with an embodiment described above, the composition (a) of the layer A comprises, as highly breathable polymer, a TPA, it preferably exhibits a melt flow index (or MFI), measured for a temperature of 190° C. and a total weight of 2.16 kg, ranging from 0.01 to 100 g/10 minutes, preferably from 0.1 to 50 g/10 minutes.

When, in accordance with an embodiment described above, the composition (a) of the layer A comprises, as highly breathable polymer, a TPU, it preferably exhibits a melt flow index (or MFI), measured for a temperature of 190° C. and a total weight of 8.7 kg, ranging from 0.01 to 100 g/10 minutes, preferably from 1 to 80 g/10 minutes.

When, finally, in accordance with an embodiment described above, the composition (a) of the layer A comprises, as highly breathable polymer, a TPC, it preferably exhibits a melt flow index (or MFI), measured for a temperature of 230° C. and a total weight of 2.16 kg, ranging from 0.01 to 200 g/10 minutes, preferably from 1 to 100 g/10 minutes.

The use of these last three embodiments is advantageous with a view to the manufacture of the monolayer film according to the invention, which is described below.

The melt flow index (or MFI) is measured for the temperature indicated and the total weight indicated, in accordance with the standard ISO 1133. The MFI is the weight of composition (placed beforehand in a vertical cylinder) which flows during a specified time interval through a die with a diameter of 2.095 mm, under the effect of a pressure exerted by a loaded piston with the total weight indicated. The specified time interval is reduced to 10 minutes by the calculation.

Process for the Manufacture of the Monolayer Film A:

Another subject matter of the present invention is a process for the manufacture of the monolayer film A according to the invention, said process comprising:
a stage (i) of formation, by coextrusion, of a multilayer film M comprising a bilayer B/A, in which:
   the layer A is as defined above, and
   the layer B is a peelable layer, the thickness of which ranges from 15 to 100 μm, preferably from 20 to 55 μm, and which consists of a composition (b) in the form of a dispersion of high density polyethylene (HDPE) in a continuous phase of atactic PolyPropylene (PP), the amount of dispersed HDPE being such that layer B exhibits, on both its faces, an arithmetical mean roughness Ra of at least 0.1 μm; then
a stage (ii) of separation of the monolayer film A by peeling off the layer B in the multilayer film M.

It has been found, surprisingly, that the particular composition (b) of the layer B has the effect of creating, on both its faces, a specific surface roughness, capable of also ensuring a substantially identical roughness for the face of the layer A which is in contact with the layer B.

Composition (b) of the Peelable Layer B:

The composition (b) of the peelable layer B consists of a dispersion of high density polyethylene (HDPE) in a continuous phase of atactic PolyPropylene (PP).

PolyPropylene is understood to mean, within the meaning of the present invention, a propylene homopolymer or a random copolymer of propylene with, as comonomer, an α-olefin which can be chosen in particular from: ethylene, 1-butene, 1-pentene, 1-hexene, methyl-1-butene, 4-methyl-1-pentene and 1-decene.

In the scientific nomenclature of polymers, the term “tacticity” is used to describe the configuration of the chain, that is to say the stereochemical structure of a polymer chain.

A polymer is said to be isotactic if it has a chain configuration described as having the radical groups attached to the tertiary carbon atoms of successive monomer units on the same side of a hypothetical plane drawn through the main polymer chain. This type of stereochemical structure can be illustrated graphically by:

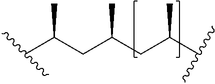

Polypropylene having this type of chain configuration is known under the name of isotactic polypropylene or iPP.

A polypropylene chain can also adopt a syndiotactic configuration in which the tertiary methyl groups of the successive monomer units along the chain are arranged alternately on either side of the hypothetical plane. The stereo configuration of the syndiotactic chain can be described below:

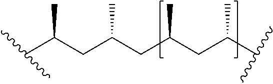

Polypropylene having this type of chain configuration is called syndiotactic polypropylene or sPP.

In contrast to a regular spatial configuration, a propylene polymer chain can also have a chain stereochemical structure characterized in that the methyl groups of the successive monomer units are distributed, sterically, in a random fashion on either side of the hypothetical plane through the polymer chain. This configuration of the chain is defined as atactic. The stereo configuration of the molecular chain of the atactic polypropylene (aPP) can be illustrated graphically by:

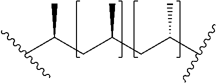

Atactic polypropylene is an essentially amorphous polymer, which can be prepared by conventional processes, using specific catalysts known to a person skilled in the art, such as described, for example, in the patent EP 0 394 237 B 1. An atactic polypropylene is, for example, commercially available from BassTech International or from PolymerTeam, under the name APP Homopolymer (APPH) or APP Copolymer (APPC).

High density polyethylene (or HDPE) is a polyethylene which can be produced by polymerization by Ziegler-Natta catalysis or by metallocene-type catalysis, and the density of which is within a range extending from 0.940 to 0.970 g/cm³. It is widely available commercially, for example from Total.

High density polyethylene (or HDPE) is generally present in the continuous phase of atactic PP of the dispersion (b) in the form of nodules, the size of which is between 0.5 and 10 μm, preferably between 0.7 and 7 μm.

The dispersion (b) can be prepared in the form of granules with a size of between 1 and 10 mm, preferably between 2 and 6 mm, by simple hot mixing of PP granules with a size of between 1 and 10 mm and of HDPE in the form of a powder, the constituent particles of which have a size of approximately a few hundred μm.

The amount of HDPE dispersed in the continuous phase of atactic PolyPropylene is such that layer B exhibits, on both its faces, an arithmetical mean roughness Ra of at least 0.1 μm. The arithmetical mean roughness Ra is defined and measured as indicated above.

According to a preferred alternative form of the process according to the invention, the amount of HDPE dispersed in the continuous phase of atactic PolyPropylene is such that the arithmetical mean roughness Ra is of at least 0.3 μm and more preferably still of at least 0.5 μm.

According again to a preferred embodiment, the amount of HDPE dispersed in the continuous phase of atactic PolyPropylene is such that the layer B exhibits, on both its faces, in addition to the characteristic defined above for the Ra, a number of peaks per unit of length RPc of at least 40, preferably of at least 50 and more preferably still of at least 60. The number of peaks per unit of length RPc is also defined and measured as indicated above.

According to an also preferred embodiment, the amount of HDPE dispersed in the atactic PP, expressed on the basis of the total weight of dispersion (b), is within a range extending from 5% to 50% by weight, preferably from 35% to 48% by weight.

According to an alternative form of the invention, the dispersion (b) based on atactic PP advantageously comprises, in addition to the HDPE, an antioxidizing agent, as defined above for the composition (a), in an amount which can vary from 0.5% to 5% by weight, based on the total weight of dispersion (b).

According to another preferred alternative form of the invention, the composition (b) exhibits a melt flow index (or MFI) which:
when it is measured at a temperature of 190° C. and a total weight of 2.16 kg, is within a range extending from 0.01 to 100 g/10 minutes, preferably from 0.1 to 50 g/10 minutes;
when it is measured at a temperature of 190° C. and a total weight of 8.7 kg, is within a range extending from 0.01 to 100 g/10 minutes, preferably from 1 to 80 g/10 minutes; and
when it is measured at a temperature of 230° C. and a total weight of 2.16 kg, is within a range extending from 0.01 to 200 g/10 minutes, preferably from 1 to 100 g/10 minutes.

Stage (i) and Multilayer Film M:

The multilayer film M formed on conclusion of stage (i), in accordance with the process for the manufacture of the monolayer film A according to the invention, comprises the bilayer B/A as defined above.

According to a preferred embodiment of the invention, the multilayer film M consists of said bilayer B/A.

According to another equally preferred embodiment of the invention, the multilayer film M comprises, and preferably consists of, a trilayer B/A/C, in which the layer C is a peelable layer, the thickness of which ranges from 15 to 100 μm, preferably from 20 to 55 μm, and consists of a composition (c) of a low density polyethylene (or LDPE) which also includes a linear low density polyethylene (or LLDPE) and a mixture of LDPE and LLDPE. LDPE or low density polyethylene is understood to mean a polyethylene manufactured by radical polymerization, the density of which is within a range extending from 0.910 to 0.935 g/cm³.

According to another more preferred embodiment of the invention, the multilayer film M comprises, and preferably consists of, a trilayer B/A/C, in which the layer C is a peelable layer which corresponds to the same definition as the layer B, and which is identical to (or different from) B. Even more particularly preferably, the layers B and C are identical and called S, the multilayer film M then being a symmetrical trilayer S/A/S.

Said multilayer film M is therefore an intermediate employed in stage (i) of the process according to the invention, which is also a subject matter of the invention, and also its embodiments described above.

According to a 1^{st} alternative form of the invention, stage (i) is carried out by flat coextrusion.

According to a 2^{nd} alternative form of the invention, which is preferred, stage (i) is carried out by coextrusion by film blowing.

According to a particularly preferred embodiment of this 2^{nd} alternative form, stage (i) comprises the stages:
(i1) of introduction, into separate extruders, of the compositions (a), (b) and if appropriate (c), in the form of granules with a size of between 1 and 10 mm, preferably between 2 and 5 mm; then
(i2) of transformation by heating said granules to the molten state; then
(i3) of passage of the corresponding flows through an extrusion head comprising a set of coplanar and concentric annular dies, which head is brought to a temperature ranging from 150° C. to 260° C., so as to form, by injection of pressurized air, a tubular bubble (or sheath) in the shape of a cylinder having several layers, the order of the layers of which corresponds to that desired for the final film, the layer A being on the outside of the tubular sheath in the case of the bilayer B/A; then
(i4) of radial (relative to the plane of the annular dies) expansion and of drawing (in the direction perpendicular to said plane) of the bubble; then
(i5) of cooling of said bubble.

According to a preferred alternative form, prior to stage (i1), the granules intended to be introduced into the extruders are dried for an appropriate time and at an appropriate temperature.

The composition (a) which is introduced into an extruder is advantageously provided, in the case where it comprises the additives described above, in the form of a mixture comprising the granules of highly breathable polymer and the granules of one (or more) masterbatch(es) in which one or more additives are combined with a support thermoplastic resin.

Stage (ii):

Stage (i) of formation, by coextrusion, of the multilayer film M is followed by stage (ii) of separation of the monolayer film A by peeling off the layer B and, if appropriate, the layer C by simple mechanical separation, then winding of the layer B and, if necessary, of the layer C onto as many cylinders distinct from that onto which the monolayer film A is wound. Said mechanical separation can, for example, be carried out at the industrial level by initiation using two rolls of an adhesive tape, the forces of adhesion of which to the outer faces of the bilayer B/A are much greater than the force of adhesion bonding the layers B and A. The separation of the monolayer film A by peeling is easily obtained due to the incompatibility of the compositions (b) and (c) relative to the composition (a) and is carried out industrially in a way known to a person skilled in the art.

The present invention also relates to a laminated product comprising the monolayer monolithic waterproof-breathable film according to the invention and a porous support layer consisting of a fibrous material.

Said fibrous material can comprise a woven or nonwoven material and the basis weight of the support layer can vary from 5 to 500 g/m², preferably from 10 to 300 g/m².

Said laminated product is often obtained by fixing said film to the support layer by lamination by means of a lamination adhesive, for example a polyurethane adhesive or a hot-melt adhesive. This adhesive is applied by continuous or noncontinuous coating by means of processes known to a person skilled in the art.

The present invention finally relates to the use of said laminated product for the manufacture of articles, in particular in the field of textiles, especially clothing, in particular sportswear or surgical protective clothing, and personal protective equipment, and in the construction and health fields.

The following examples are given purely by way of illustration of the invention and should not under any circumstances be interpreted in order to limit the scope thereof.

### EXAMPLES

### Example 1 (Comparative): Preparation of a Monolithic and Monolayer Waterproof-Breathable Film A1 of a Pebax® Copolymer Having Polyamide and Polyether Blocks, Comprising the Formation by Coextrusion of a Trilayer S1/A1/S1 where the Layer S1 Consists of LDPE

Use is made, as constituent composition (a1) of the layer A1, of a composition consisting of a copolymer having polyamide and polyether blocks comprising polyamide 11 blocks with a molar mass of 1000 g/mol and PolyEthylene Glycol (PEG) blocks with a molar mass of 1500 g/mol. Said copolymer can be obtained from Arkema under the Pebax® name, and its MFI, measured at 190° C. for a weight of 2.16 kg according to the standard ISO 1133, is 20 g/10 min. Said copolymer is available in the form of granules with a size of between 2 and 6 mm.

Use is made, as constituent composition of the layer S1, of the LDPE Escorenev 185JD from Exxon Mobil. This LDPE has a density equal to 0.923 g/cm³ and an MFI, measured at 190° C. for a weight of 2.16 kg, equal to 2 g/10 min and is provided in the form of granules with a size of between 2 and 5 mm.

(i) Formation of the Trilayer Film S1/A1/S1:

This trilayer film is manufactured by means of a pilot device for coextrusion by film blowing, the total flow rate of which can vary from 15 to 35 kg/hour and the die of which has a diameter of 7 cm.

This continuously operating device comprises three screw extruders which are fed:
for one brought to a temperature of 180° C., with the composition (a1) of the layer A1, and
for each of the other two brought to a temperature of 180° C., with the composition of the layer S1;

these compositions being in the form of granules with a size of approximately 4 mm.

This pilot device comprises an extrusion head, the annular die of which is brought to a temperature of 190° C.

The parameters of the process are adjusted so as to manufacture a trilayer film consisting:
of a layer A1 with a thickness of 15 μm consisting of the composition (a1),
of two identical support layers S1 with a thickness of 30 pin consisting of LDPE.

Mention may be made, among the parameters usually set, of a blow ratio of the bubble equal to 2.6, a drawing speed (corresponding to the line speed) of 10.7 m/minute and a total throughput of 25 kg/hour.

The trilayer film thus obtained has a total thickness of 75 pin and a length of 50 m and is packaged in the form of a reel with a machine width of 280 mm.

(ii) Separation of the Layer A1 by Peeling Off the Two Layers S1:

The layer A1 is manually separated from the two layers S1 by peeling off over a length of film of 2 m.

Samples of the layer A1 and of a layer 51 thus obtained are subjected to the following measurements and tests.

The arithmetical mean roughness Ra and the number of peaks RPc are determined using the Dektak XT profilometer from Bruker, on one face of the layers A1 and S1.

The results are shown in table 1.

The gloss was measured on one of the faces of the layer A1, along an angle of 60° in relation to the perpendicular to the surface of a sample withdrawn in the machine direction, using a Zehntner ZGM 1120 glossmeter and in accordance with the standard ASTM D 2457.

The gloss, expressed in Gloss Units (GU), is shown in table 1.

The breathability of the layer A1 was quantified by measurement of the MVTR according to the standard ASTM E96 B at 38° C. and 50% relative humidity for a film with a thickness of 15 μm. The result is also shown in table 1.

The coefficient of friction of the layer A1 was measured according to the standard ISO 8295 of December 2004 as summarized below.

Measurement of the Coefficient of Friction:

Use is made, as experimental device, of an immobile horizontal test plate, of appropriate dimensions, to which is fixed a sample of the layer A1.

Another sample of the same layer A1 is also fixed, by means of an adhesive tape, to a parallelepipedal pad having a weight of 200 g and a height of 63 mm, so as to cover its square base of 4000 mm².

The pad is placed on the horizontal plate so that the two samples of layer A1 are in contact. The pad is then driven, by means of a suitable drive mechanism, with a displacement movement at a uniform speed of 150 mm/minute, relative to the immobile horizontal plate, so as to cause the two surfaces of layer A1 to slide in contact with each other.

The force of resistance to the displacement of the pad is measured by means of a dynamometer and recorded.

The coefficients of static friction Ks and of dynamic friction Kd are calculated as indicated in the abovereferenced standard.

The mean values of Ks and Kd obtained after three repetitions of the measurement are:

Ks=12.2 and Kd=12.1.

### Example 2 (According to the Invention): Preparation of a Monolithic and Monolayer Waterproof-Breathable Film a of a Copolymer Having Polyamide and Polyether Blocks (TPA), Comprising the Formation by Coextrusion of a Trilayer S/A/S where the Layer S Consists of HDPE+Atactic PP

Example 1 is repeated, using:
for the layer A, a layer of the same thickness and of the same composition as the layer A1; and
for the constituent composition of the layer S, a dispersion of HDPE in atactic PP. This is prepared by simple mixing at 200° C. of 44.9% by weight of the HDPE, of 1.6% of antioxidant and of 53.5% by weight of the atactic PP, based on the total weight of the dispersion. The mixing is carried out by means of a twin-screw extruder equipped with a tool for cutting the extruded product at the outlet of the die. Granules with a size of between approximately 2 and 6 mm are obtained, which are fed into the two screw extruders brought to a temperature of 210° C. The MFI measured for the dispersion is 1 g/10 minutes, at a temperature of 190° C. and for a weight of 2.16 kg.

The results obtained for the roughness as regards the two layers A and S, and for the gloss and the breathability as regards the layer A, are shown in table 1.

The mean values obtained for the coefficients of static friction Ks and of dynamic friction Kd of the layer A are:

Ks=0.7 and Kd=0.7.

There is observed, for the layer A of monolithic waterproof-breathable film, as for the support layer S, a surface roughness which corresponds to Ra and RPc values much higher than those observed for the layer A1 and the support layer S1 of example 1 according to the prior art. Furthermore, said layer A exhibits, in relation to the layer A1 of said example 1, coefficients of static and dynamic friction which are lowered by more than a factor of 10 and also a gloss lowered by nearly a factor of 10, corresponding to a matte and not shiny appearance. Finally, the MVTR value obtained for the layer A demonstrates excellent breathability properties characteristic of a monolithic waterproof-breathable film, comparable to those of the layer A1 of the prior art.

### Example 3 (Comparative): Preparation of a Monolithic and Monolayer Waterproof-Breathable Film A1 of an Arnitel® Copoly(Ether-Urethane) Copolymer (TPC), Comprising the Formation by Coextrusion of a Bilayer B1/A1 where the Layer B1 Consists of LDPE

Example 1 is repeated, except that:
use is made, as constituent composition (a1) of the layer A1, of a composition consisting of the TPC Arnitel® PM381 obtained from DSM, the MFI of which, measured at 230° C. for a weight of 2.16 kg according to the standard ISO 1133, is 4.7 g/10 min;
the parameters of the process are adjusted so as to manufacture a bilayer film with a total thickness of 45 μm consisting:
   of a layer A1 with a thickness of 15 μm consisting of the composition
   of a single support layer B1 with a thickness of 30 μm consisting of LDPE;

the layer A1 being on the outside of the tubular sheath.

The results obtained for the gloss and the breathability as regards the layer A1 are shown in table 1.

### Example 4 (According to the Invention): Preparation of a Monolithic and Monolayer Waterproof-Breathable Film a of the TPC Arnitel®, Comprising the Formation by Coextrusion of a Bilayer B/a where the Layer B Consists of HDPE+Atactic PP

Example 3 is repeated, using:
for the layer A, a layer of the same thickness and of the same composition as the layer A1; and
for the constituent composition of the layer B, the same dispersion of HDPE in atactic PP as that employed in example 2.

The results obtained for the gloss and the breathability as regards the layer A are shown in table 1.

### Example 5 (According to the Invention): Preparation of a Monolithic and Monolayer Waterproof-Breathable Film a of a Desmopan® Copoly(Ether-Urethane) (TPU), Comprising the Formation by Coextrusion of a Trilayer B 1/A/C where the Layer B1 Consists of LDPE and the Layer C of HDPE+Atactic PP

Example 2 is repeated, except that use is made:
for the layer A, of Desmopan® 6590A MVT, the MFI of which is 6 g/10 minutes at a temperature of 190° C. and for a weight of 8.7 kg;
for the layer B 1, of the LDPE of example 1; and
for the layer C, of the constituent dispersion of HDPE in atactic PP of the layer S.

The results obtained for the gloss and the breathability as regards the layer A are shown in table 1, the result obtained for the gloss being specified according to whether the measurement was made on the face of the layer A which is in contact with the layer B1 (known as “face B1”) or on the face of the layer A which is in contact with the layer C (known as “face C”).

### Example 6 (According to the Invention): Preparation of a Monolithic and Monolayer Waterproof-Breathable Film a of an Elastollan® Copoly(Ether-Urethane) (TPU), Comprising the Formation by Coextrusion of a Trilayer B 1/A/C where the Layer B1 Consists of LDPE and the Layer C of HDPE+Atactic PP

Example 5 is repeated, except that use is made, for the layer A, of Elastollan 1385A 12, the MFI of which is 25 g/10 minutes at a temperature of 190° C. and for a weight of 8.7 kg.

The results obtained for the gloss and the breathability as regards the layer A are shown in the same way in table 1.

TABLE 1

| | | Composition of the | | Roughness | | Layer A | |
|---|---|---|---|---|---|---|---|
| | Multilayer | layers | | Ra | | Gloss | MVTR |
| Example | film | Layer | Composition | (μm) | RPc | (GU) | (g/m²/day) |
| Ex. 1 | S1/A1/S1 | A1 | Pebax ® | 0.041 | 36 | 102.9 | 2923 |
| (comp.) | | S1 | LDPE | 0.037 | 31 | NC | NC |
| Ex. 2 | S/A/S | A | Pebax ® | 0.682 | 74 | 10.5 | 2985 |
| | | S | HDPE + | 0.734 | 69 | NC | NC |
| | | | atactic PP | | | | |
| Ex. 3 | B1/A1 | A1 | Arnitel ® | NA | NA | 91.3* | 2327 |
| (comp.) | | B1 | LDPE | NA | NA | NC | NC |
| Ex. 4 | B/A | A | Arnitel ® | NA | NA | 11.1* | 2519 |
| | | B | HDPE + | NA | NA | NC | NC |
| | | | atactic PP | | | | |
| Ex. 5 | B1/A/C | A | Desmopan ® | NA | NA | face B1: 42.5 | 2268 |
| | | | | | | face C: 12.6 | |
| | | B1 | LDPE | NA | NA | NC | NC |
| | | C | HDPE + | NA | NA | NC | NC |
| | | | atactic PP | | | | |
| Ex. 6 | B1/A/C | A | Elastollan ® | NA | NA | face B1: 42.5 | 2537 |
| | | | | | | face C: 10.1 | |
| | | B1 | LDPE | NA | NA | NC | NC |
| | | C | HDPE + | NA | NA | NC | NC |
| | | | atactic PP | | | | |

*gloss measured on the face of the layer A in contact with the 2^{nd} layer
NC = Not Concerned
NA = Not Available

1-15. (canceled)

16. A monolayer monolithic waterproof-breathable film A, the thickness of which is of between 5 and 150 μm, which consists of a composition (a) comprising at least 50% by weight, on the basis of the total weight of said composition, of a highly breathable polymer, and which is characterized in that at least one of its two faces exhibits an arithmetical mean roughness Ra of at least 0.1 μm.

17. The monolayer monolithic waterproof-breathable film as claimed in claim 16, characterized in that at least one of its two faces exhibits a number of peaks per unit of length RPc of at least 40.

18. The monolayer monolithic waterproof-breathable film as claimed in claim 16, characterized in that both its faces exhibit an arithmetical mean roughness Ra of at least 0.1 μm and a number of peaks per unit of length RPc of at least 40.

19. The monolayer monolithic waterproof-breathable film as claimed in claim 16, characterized in that the highly breathable polymer is a thermoplastic elastomer polymer, the moisture vapor transmission rate (or MVTR) of which, measured according to the standard ASTM E96B at 38° C. and 50% relative humidity on a film of said polymer with a thickness of 15 μm, is greater than or equal to 1000 g/m²/day.

20. The monolayer monolithic waterproof-breathable film as claimed in claim 16, characterized in that the highly breathable polymer is chosen from a copolymer having polyamide and polyether blocks, a copoly(ether-urethane) and a copoly(ester-ether).

21. The monolayer monolithic waterproof-breathable film as claimed in claim 20, characterized in that the highly breathable polymer is a copolymer having polyamide and polyether blocks for which the polyamide and polyether blocks are, respectively, a PolyAmide 11 (PA11) block and a PolyEthylene Glycol (PEG) block, the molar masses of which are within a range extending from 500 to 3000 g/mol.

22. The monolayer monolithic waterproof-breathable film as claimed in claim 16, characterized in that the composition (a) consists, on the basis of its total weight, of:
from 50% to 100% by weight of the highly breathable polymer(s),
from 0% to 30% by weight of additives chosen from opacifying agents, pigments, dyes, slip agents, antioxidants, antistatic agents, antiblocking agents; and
from 0% to 20% by weight of a support thermoplastic resin for said additives.

23. A process for the manufacture of the monolayer film A as defined in claim 16, said process comprising:
a stage (i) of formation, by coextrusion, of a multilayer film M comprising a bilayer B/A, in which:
the layer A is as defined above, and
the layer B is a peelable layer, the thickness of which ranges from 15 to 100 μm, and which consists of a composition (b) in the form of a dispersion of high density polyethylene (HDPE) in a continuous phase of atactic PolyPropylene (PP), the amount of dispersed HDPE being such that layer B exhibits, on both its faces, an arithmetical mean roughness Ra of at least 0.1 μm; then
a stage (ii) of separation of the monolayer film A by peeling off the layer B in the multilayer film M.

24. The process for the manufacture of the monolayer film A as claimed in claim 23, characterized in that the amount of HDPE dispersed in the atactic PP, expressed on the basis of the total weight of dispersion (b), is within a range extending from 5% to 50% by weight.

25. The process for the manufacture of the monolayer film A as claimed in claim 23, characterized in that the multilayer film M consists of the bilayer B/A.

26. The process for the manufacture of the monolayer film A as claimed in claim 23, characterized in that the multilayer film M comprises a trilayer B/A/C, in which the layer C is a peelable layer, the thickness of which ranges from 15 to 100 μm, and consists of a composition (c) of low density polyethylene (LDPE).

27. The process for the manufacture of the monolayer film A as claimed in claim 23, characterized in that the multilayer film M comprises a trilayer B/A/C, in which the layer C is a peelable layer which corresponds to the same definition as the layer B, and which is identical to (or different from) B.

28. A multilayer film M comprising a bilayer B/A which can be used as intermediate in the process as defined in claim 23.

29. A laminated product comprising the monolayer monolithic waterproof-breathable film as defined in claim 16 and a porous support layer consisting of a fibrous material.

30. An article in the textile, construction and health fields comprising the laminated product of claim 29.
